(19) United States
(12) Patent Application Publication
(10) Pub. No.: US 2021/0318851 A1
(43) Pub. Date: Oct. 14, 2021

(54) Systems and Methods for Dataset Merging using Flow Structures

(71) Applicant: Virtualitics, Inc., Pasadena, CA (US)

(72) Inventors: Sarthak Sahu, Pasadena, CA (US); Michael Amori, Pasadena, CA (US); Ciro Donalek, Pasadena, CA (US); Justin Gantenberg, Pasadena, CA (US); Aakash Indurkhya, Pasadena, CA (US)

(73) Assignee: Virtualitics, Inc., Pasadena, CA (US)

(21) Appl. No.: 17/226,943

(22) Filed: Apr. 9, 2021

Related U.S. Application Data
(60) Provisional application No. 63/007,879, filed on Apr. 9, 2020.

(51) Int. Cl. G06F 7/14; G06F 9/451; G06F 16/215; G06F 16/901; G06N 20/00; G06N 5/04

(52) U.S. Cl. CPC G06F 7/14; G06F 9/451; G06N 5/04; G06F 16/9024; G06N 20/00; G06F 16/215

(57) ABSTRACT

Systems and methods for dataset merging using flow structures in accordance with embodiments of the invention are illustrated. Flow structures can be generated and sent to various computing devices to generate both the front-end and back-end of a customized computing system that can perform any number of various processes including those that merge datasets. In many embodiments, machine learning and/or natural language processing can be performed by the customized application.

### CROSS-REFERENCE TO RELATED APPLICATIONS

The current application claims priority under 35 U.S.C. 119(e) to U.S. Provisional Patent Application Ser. No. 63/007,879, entitled “Systems and Methods for Dataset Merging and Insight Extraction”, filed Apr. 9, 2020. The disclosure of U.S. Provisional Patent Application Ser. No. 63/007,879 is hereby incorporated herein by reference in its entirety.

### FIELD OF THE INVENTION

The present invention generally relates to dataset merging, namely the automated merging of different datasets with different structures, and subsequent analysis orchestrated using a flow structure as defined herein.

### BACKGROUND

Datasets are a collection of data. Many datasets are organized as tables (e.g. as a spreadsheet). However many datasets are merely collections of loosely structured or unstructured data. Databases are data structures which contain different types of data in an enforced schema. Queries can be made of databases to retrieve information stored inside. Databases can be relational (tabular), or non-relational. Different databases can be used for different types of data. The structure of data within a database is described by its schema. Data can also be stored in an unstructured fashion, such as a collection of documents.

Progressive web applications (PWAs) are a type of software that is delivered through the Internet that is intended to work on any platform that uses a standard-compliant browser.

### SUMMARY OF THE INVENTION

Systems and methods for dataset merging using flow structures in accordance with embodiments of the invention are illustrated. One embodiment includes a data processing system includes a flow server configured to obtain a list of desired processing modules selected from a plurality of processing modules, generate a flow structure including a plurality of steps, where each desired processing module in the list of desired processing modules is associated with at least one step in the plurality of steps, and a plurality of links, where each link connects a unique pair of steps in the plurality of steps, and transmit the flow structure to a data processor storing the plurality of processing modules, and to a front-end device, the front-end device configured to display a user interface (UI) for each step in the plurality of steps based on the flow structure, where one UI is displayed at a time, obtain input data via the UI for a given step when required for processing modules associated with the given step, transmit the obtained data to the data processor, receive processed data from the data processor, and display the processed data using a UI for a different step, and the data processor configured to receive data from the front-end device, process the received data using the processing modules associated with the given step, and transmit the output of the processing modules associated with the given step as the processed data to the front-end device.

In a further embodiment, each respective step in the plurality of steps includes a label, and a unique ID.

In still another embodiment, at least one of the label and the unique ID identifies processing modules associated with the respective step.

In a still further embodiment, each link includes a unique ID of a preceding step and a unique ID of a next step.

In yet another embodiment, a processing module in the plurality of processing modules cleans a dataset.

In a yet further embodiment, a processing module in the plurality of processing modules validates a dataset.

In another additional embodiment, a processing module in the plurality of processing modules generates predictions from a dataset using a machine learning model.

In a further additional embodiment, the input data is a first dataset and a second dataset; and the at least one processing module associated with the given step merges the first dataset and the second dataset.

In another embodiment again, the plurality of steps form nodes in a directed acyclic graph, and the links form edges in the directed acyclic graph.

In a further embodiment again, a method for data processing includes obtaining a list of processing modules selected from a plurality of processing modules using a flow server, generating a flow structure using the flow server, where the flow structure includes a plurality of steps, where each desired processing module in the list of desired processing modules is associated with at least one step in the plurality of steps, and a plurality of links, where each link connects a unique pair of steps in the plurality of steps, and transmitting the flow structure to a data processor storing the plurality of processing modules, and to a front-end device, displaying a user interface (UI) for each step in the plurality of steps based on the flow structure, where one UI is displayed at a time using the front-end device, obtaining input data via the UI for a given step when required for processing modules associated with the given step using the front-end device, transmitting the obtained data to the data processor using the front-end device, receiving data from the front-end device using the data processor, processing the received data using the processing modules associated with the given step using the data processor, and transmitting the output of the processing modules associated with the given step as the processed data to the front-end device using the data processor, receiving processed data from the data processor using the front-end device, and displaying the processed data using a UI for a different step using the front-end device.

In still yet another embodiment, each respective step in the plurality of steps includes a label, and a unique ID.

In a still yet further embodiment, at least one of the label and the unique ID identifies processing modules associated with the respective step.

In still another additional embodiment, each link comprises a unique ID of a preceding step and a unique ID of a next step.

In a still further additional embodiment, a processing module in the plurality of processing modules cleans a dataset.

In still another embodiment again, a processing module in the plurality of processing modules validates a dataset.

In a still further embodiment again, a processing module in the plurality of processing modules generates predictions from a dataset using a machine learning model.

In yet another additional embodiment, the input data is a first dataset and a second dataset; and the at least one processing module associated with the given step merges the first dataset and the second dataset.

In a yet further additional embodiment, the plurality of steps form nodes in a directed acyclic graph, and the links form edges in the directed acyclic graph.

In yet another embodiment again, a flow server for coordinating data processing across multiple computing devices includes a processor, and a memory, containing a flow generation application, where the flow generation application directs the processor to obtain a list of functions for an application, where each function is capable of being performed by at least one processing module in a plurality of processing modules, generate a plurality of steps, where each step in the plurality of steps is associated with one or more processing modules in the plurality of processing modules, generate a plurality of links, where each link connects a unique pair of steps in the plurality of steps, generate a flow structure comprising the plurality of steps and the plurality of links, and transmit the flow structure to a front-end device and a data processing device, where the front-end device uses the flow structure to generate a given UI element for each given step in the plurality of steps; and where the data processing device applies a processing module associated with the given step to data acquired via the given UI element.

In a yet further embodiment again, the plurality of steps and the plurality of links can be represented as a directed acyclic graph, where steps are nodes and links are edges.

In another additional embodiment again, a dataset merging system includes a flow server configured to obtain a list of desired processing modules selected from a plurality of processing modules, generate a flow structure includes a plurality of steps, where each desired processing module in the list of desired processing modules is associated with at least one step in the plurality of steps, and a plurality of links, where each link connects a unique pair of steps in the plurality of steps, and transmit the flow structure to a dataset merger and a front-end device, the front-end device configured to display a user interface (UI) for each step in the plurality of steps based on the flow structure, where one UI is displayed at a time, obtain a first dataset and a second dataset using a UI for at least one step in the plurality of steps, transmit the first dataset and the second dataset to the dataset merger, receive a merged dataset comprising data from the first dataset and the second dataset from the dataset merger, and displaying the merged dataset at another UI for another step in the plurality of steps, and the dataset merger configured to receive the first dataset and the second dataset, merge the first dataset and the second dataset using a processing module associated with the at least one step, and transmit the merged dataset to the front-end device.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a dataset merging system architecture in accordance with an embodiment of the invention.

FIG. 2 is a block diagram for a dataset merger in accordance with an embodiment of the invention

FIG. 3 is a block diagram for a flow server in accordance with an embodiment of the invention.

FIG. 4 is a block diagram for a front-end device in accordance with an embodiment of the invention.

FIG. 5 is a conceptual illustration of example set of steps and links in a flow structure in accordance with an embodiment of the invention.

FIG. 6 is a conceptual illustration of another example set of steps and links in flow structure in accordance with an embodiment of the invention.

FIG. 7 is a flow chart for a process for generating and providing flow structures in accordance with an embodiment of the invention.

FIG. 8 is a communication diagram showing data flow between flow servers, dataset mergers, and front-end devices in accordance with an embodiment of the invention.

FIG. 9 is a flow chart for a process for merging datasets in accordance with an embodiment of the invention is illustrated.

FIG. 10 illustrates a pipeline representing a merging and insight extraction process in accordance with an embodiment of the invention.

FIG. 11 is a diagram illustrating various tasks in an automated data diagnostic battery in accordance with an embodiment of the invention.

FIGS. 12-15B illustrate UI elements for a software package performing dataset merging and insight extraction processes in accordance with embodiments of the invention.

### DETAILED DESCRIPTION

Data management is a core task for many organizations, regardless of field of operation. For many organizations, multiple datasets are used across different divisions or even within a single division, for better or for worse. This may be due to any number of reasons including, but not limited to, having too much data to properly store in a single storage system, management of specific datasets that contain only the data required for a particular application, or merely lack of communication between different divisions of the organization. However, it is often valuable to be able to operate on data at once when looking for trends or new insights. When data is siloed in different datasets, it can be difficult to analyze all of the data at once. That said, merging datasets is not a simple task.

A naïve merge of two or more non-identical datasets often results in a poor-quality merged dataset. In many cases, the data contained within different datasets might not line up, reuse variables, or be seemingly unrelated. Further, any errors datasets tend to compound and become more difficult to handle when merged into a large dataset. For tabular datasets, it can be even more difficult as not every row and column may be compatible. As such, it can be beneficial for a customized tool for a specific merge to be generated that is specifically designed to handle the idiosyncrasies of the inputs.

Datasets can be stored in databases, which provide a useful structure for querying and managing data. Databases enforce structure on one or more datasets using a schema. Merging databases poses similar problems as merging datasets, and in many embodiments, causes additional issues. For example, a given database schema may c information that could be lost when merged with a different schema. Conventionally, datasets are either merged by hand or using purpose-built applications for a specific set of databases. However, generating purpose-built applications is a cumbersome process requiring significant labor each time new data sets are introduced.

Systems and methods described herein can address these issues by automatically generating dataset set specific tools to merge and validate datasets. In many embodiments, a single data structure, referred to herein as a “flow structure” can be used to direct the creation of a merging tool. In various embodiments, the flow structure is used to drive a web application that functions as the merging tool. In many embodiments, the flow structure is used to run various processing steps on acquired data. Flow structures can be generated by flow servers and can be used to create both a front-end container at a front-end device and a back-end container at a dataset merger. The front-end container can be used to obtain datasets for merging and analysis as well as provide an interface for users to control and select processing steps. The back-end container can used to perform the merges and analysis as directed by the user via the front-end container. Despite their different functionalities, a single flow structure can be used by both sides to perform their various functions.

Systems and methods described herein can provide insights into merged datasets by providing any of a number of dataset analysis tools. Systems and methods described herein can equally be applied to datasets, databases, and/or any other data storage structure as appropriate to the requirements of specific applications of embodiments of the invention. However, as can be readily appreciated, systems and methods described herein do not necessarily have to merge datasets, and instead can perform any number of different analytics and data presentation functions without departing from the scope of spirit of the invention. Indeed, systems and methods described herein can be referred to as “data processing systems” and “data processing methods” respectively in the instance where dataset merging is not performed or is not the main function of the resulting application. Dataset merging systems are described in further detail below.

### Dataset Merging Systems

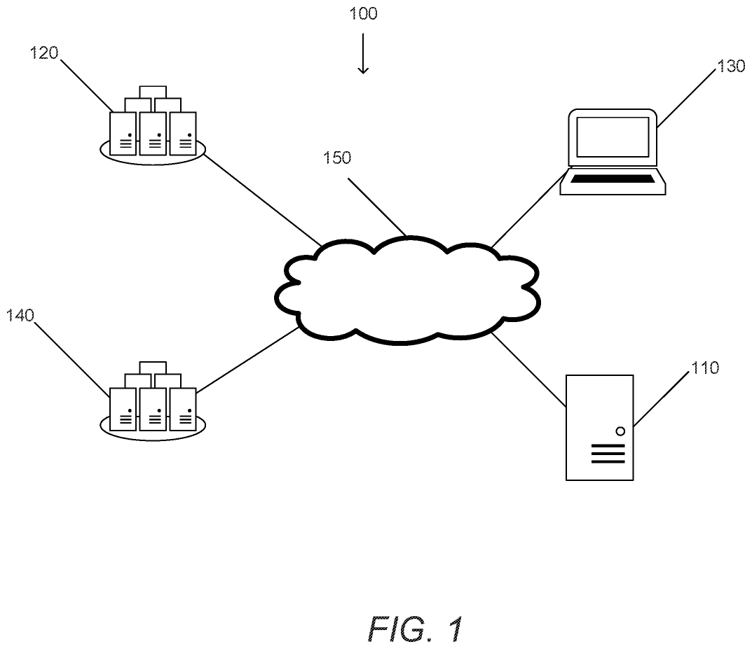

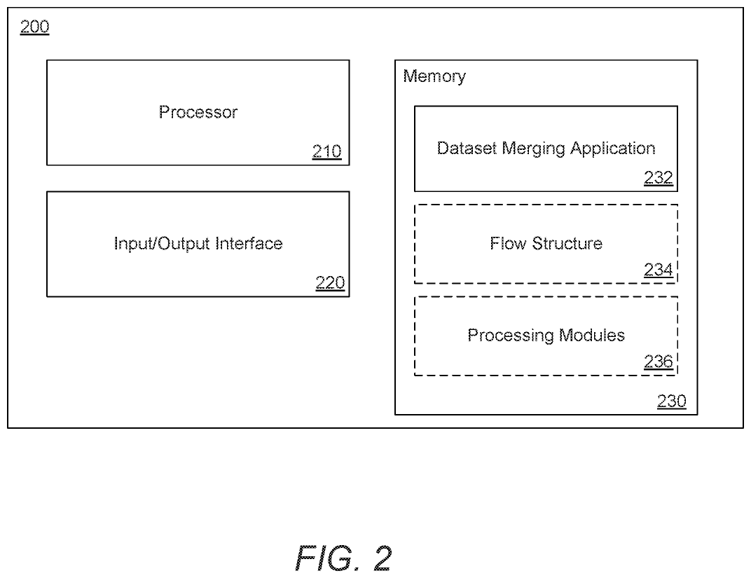

Dataset merging systems can obtain different datasets and information regarding their relation and create a purpose-built tool to merge and validate the datasets. At a high level, dataset merging systems can produce flow structures which are used to direct the acquisition and processing of datasets. As noted above, a single flow structure can be used to orchestrate the entire system. In many embodiments, flow structures are generated by flow servers, and the structures are disseminated to front-end devices and dataset mergers. However, as can be readily appreciated, front-end devices, dataset mergers, and/or flow servers can all be implemented on one or more computing platforms as appropriate to the requirements of specific applications of embodiments of the invention. In many embodiments, dataset merging systems further enable visualization of and/or insight generation from the merged dataset. Turning now to FIG. 1, a dataset merging system in accordance with an embodiment of the invention is illustrated.

System 100 includes a dataset merger 110. In many embodiments, the dataset merger is implemented on a cloud computing platform such as, but not limited to, Amazon AWS, Microsoft Azure, and/or any other cloud server system for reliability and/or access to additional computing resources. However, dataset mergers can be implemented using single servers, personal computers, and/or any other computing device as appropriate to the requirements of specific applications of embodiments of the invention. Dataset merger 110 acquires datasets from dataset storage devices 120. Dataset storage devices can include any computing device capable of storing a dataset including, but not limited to, servers, server clusters, personal computers, tablet computers, RAID arrays, and/or any other storage device as appropriate to the requirements of specific applications of embodiments of the invention. However, dataset mergers may have datasets already in memory (e.g. those that were created or maintained using the dataset merger).

The system further includes a front-end device 130. Front-end devices can be monitors, tablet computers, smart phones, and/or any other controllable screen capable of receiving user input as appropriate to the requirements of specific applications of embodiments of the invention. In many embodiments, the front-end device and the dataset merger may be the same device. Dataset mergers and/or front-end devices can also acquire flow structures from flow servers 140. Flow structures are data structures that contains structured information that can be interpreted to generate a customized web application. Front-end devices can use flow structures to generate UIs and/or to direct data to the proper location. In many embodiments, the dataset merger drives the display and/or functionality of the web application. In various embodiments, the dataset merger obtains data describing the web application in its entirety.

Dataset storage devices, front-end devices, and dataset mergers can be connected via a network 150. Networks can be wired, wireless, or a combination thereof. Network 150 can be made of many different networks in communication with each other. In numerous embodiments, network 150 includes the Internet.

A dataset merger in accordance with an embodiment of the invention is illustrated in FIG. 2. Dataset merger 200 includes a processor 210. Processors can be any processing unit capable of performing logic calculations such as, but not limited to, central processing units (CPUs), graphics processing units (GPUs), application-specific integrated circuits (ASICs), field-programmable gate arrays (FPGAs), or any other processing device as appropriate to the requirements of specific applications of embodiments of the invention. Dataset merger 200 further includes at least one input/output (I/O) interface 220. I/O interfaces can enable communication between the dataset storage devices, displays, and/or other devices capable of communicating with the system. In many embodiments, multiple I/O interfaces are used to accommodate different communication methods between components.

The dataset merger 200 further includes a memory 230. Memory 230 can be any type of memory, such as volatile memory or non-volatile memory. The memory 230 contains a dataset merging application 232. In various embodiments, the dataset merging application is executed in a browser window. In various embodiments, the memory also includes a flow structure 234 and processing modules 236. In many embodiments, the processing modules are one or more distinct modules that each perform a specific function such as (but not limited to), cleaning, validating, merging, displaying, and analyzing datasets. As can be readily appreciated, processing modules can perform any number of different functions without departing from the scope or spirit of the invention, including those unrelated specifically to dataset merging. For example, in many embodiments, processing modules that perform feature engineering processes, train machine learning and/or natural language processing (NLP) models, generate predictions from machine learning and/or NLP models, creating reports on datasets, and/or any other process as appropriate to the requirements of specific applications of embodiments of the invention. In many embodiments, systems and methods described herein can be referred to as “data processing” systems and methods as opposed to “dataset merging” systems and methods depending on the functionality provided by selected processing modules.

The dataset merging application can configure the processor to perform dataset merging processes which are described in further detail below. Additionally, while a specific system architecture and dataset merger are discussed above, one of ordinary skill in the art can appreciate that any number of different architectures can be used as appropriate to the requirements of specific applications of embodiments of the invention.

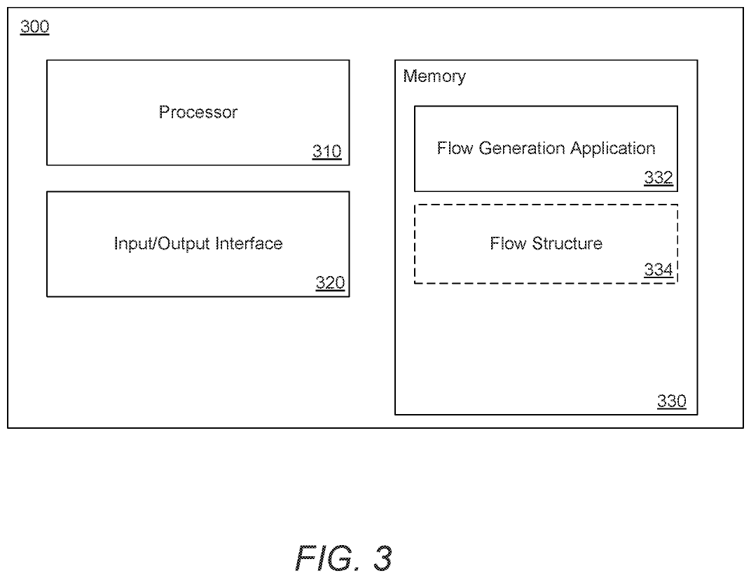

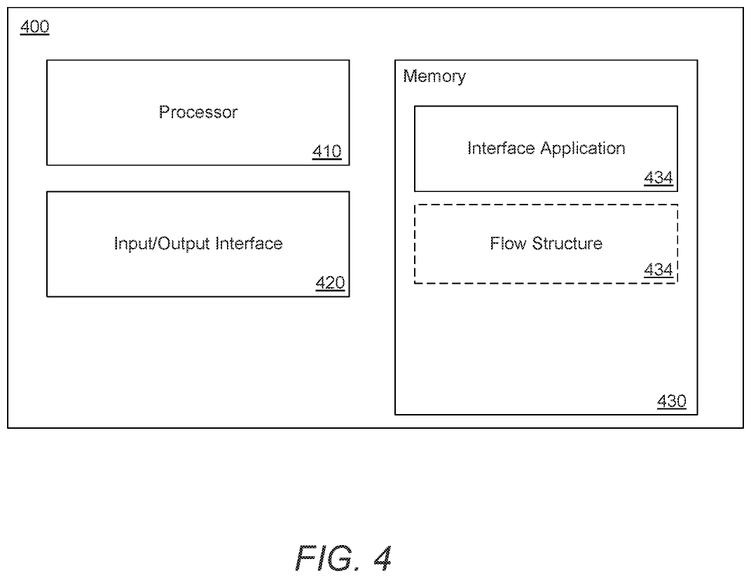

Similar to the dataset merger, a flow server and a front-end device in accordance with respective embodiments of the invention are illustrated in FIGS. 3 and 4, respectively. The flow server 300 contains a processor 310, and an I/O interface 320 similar to those described above. The memory 330 contains a flow generation application 332 which can be used to generate flow structure 334. The front-end device 400 includes a processor 410 and an I/O interface 420 similar to those described above. The memory 430 contains an interface application 434 and a flow structure 434. In a single dataset merging system, the same flow structure can be found in the memory of all of the flow server, the dataset merger, and the front-end device at some point during operation. Flow structures are explained in further detail below.

### Flow Structures

At a high level, flow structures are data structures that contains structured information that can be interpreted to coordinate functionality between multiple computing devices using only a single copy of the data structure on each device. As discussed herein, flow structures are used to merge datasets and to provide insights. However, as can be readily appreciated given the content herein, flow structures can be used to implement any number processes unrelated to dataset merging. In this case, flow structures can be more generally used in data processing systems which architecturally function similarly to dataset merging systems but do not necessarily merge any datasets. Also in this case, dataset mergers may be referred to as data processors. More specifically, in many embodiments, a flow structure is a single data structure which contains all of the information necessary to display a user-friendly interface which facilitates the acquisition of the correct datasets to be merged. In various embodiments, a single flow structure can define the necessary steps that can be used to merge two or more given datasets. A significant advantage of the flow structure is that modification of only a few parameters can enable a completely different customized dataset merging process to be performed. This enables rapid deployment and ease of use. Further, the flows can be executed on a very wide variety of computing devices as they can be executed in a regular browser window using a state machine.

In numerous embodiments, flows are made up of “steps” and “links”. Each step is a state in the state machine, and each link connects two states. As used herein, a step is a part of a flow that optionally requires some sort of user input and/or interaction and necessarily requires some kind of output report to share with a user. Each step can be associated with one or more processing modules. When arriving at a step, the processing module can be called to act on the data provided to the step by the link. In many embodiments, links direct data flow between different steps. Steps are visualized as UI pages which are presented to the user in the browser. Selecting specific UI elements, (often buttons but not necessarily so, and can be any other interactive element or the like), can trigger a link. Links originate from a step and terminate at a step such that a new step (and therefore page) is displayed after a link is processed.

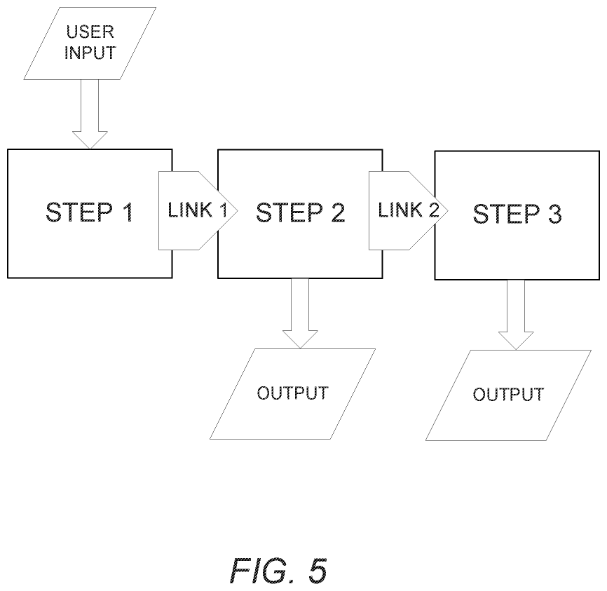

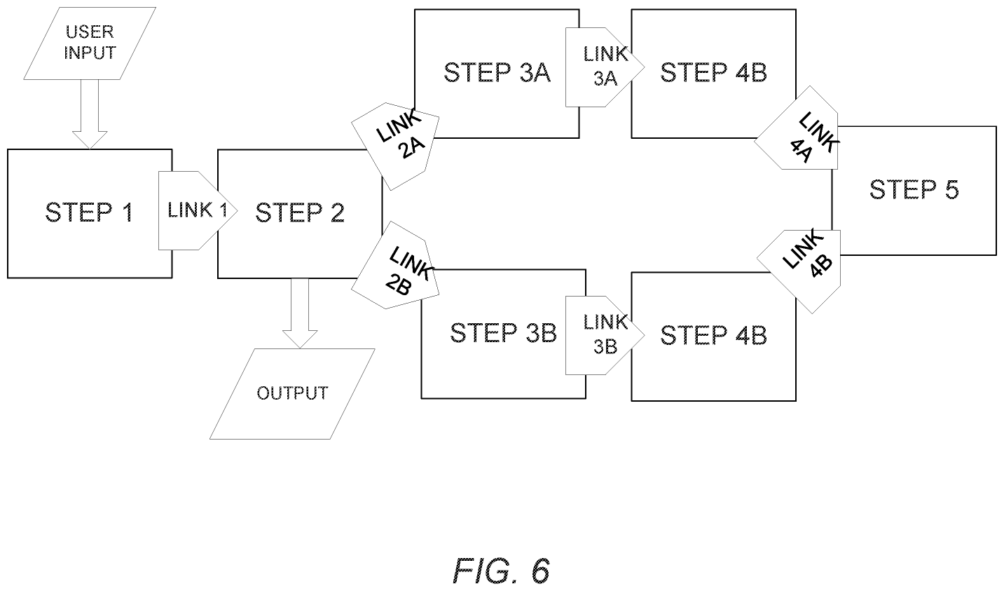

By way of example, a first step may request a user to provide two datasets. Upon pointing to the two dataset locations, a link can be triggered which ingests the two data sets and subsequently triggers a second step which displays a summary of the now loaded datasets. A second link can be triggered from the second step which performs the merge and displays the output and provides the merged dataset at a third step. All of these steps and links can be defined in a single flow, which can have branching steps and links, which can further be visualized as a directed acyclic graph (DAG). This simple example in accordance with an embodiment of the invention is illustrated in FIG. 5. As can be readily appreciated, the resulting set of steps and links can be significantly more complex and branching as appropriate to the requirements of specific applications of embodiments of the invention. An additional example of a more complex flow structure in accordance with an embodiment of the invention is illustrated in FIG. 6.

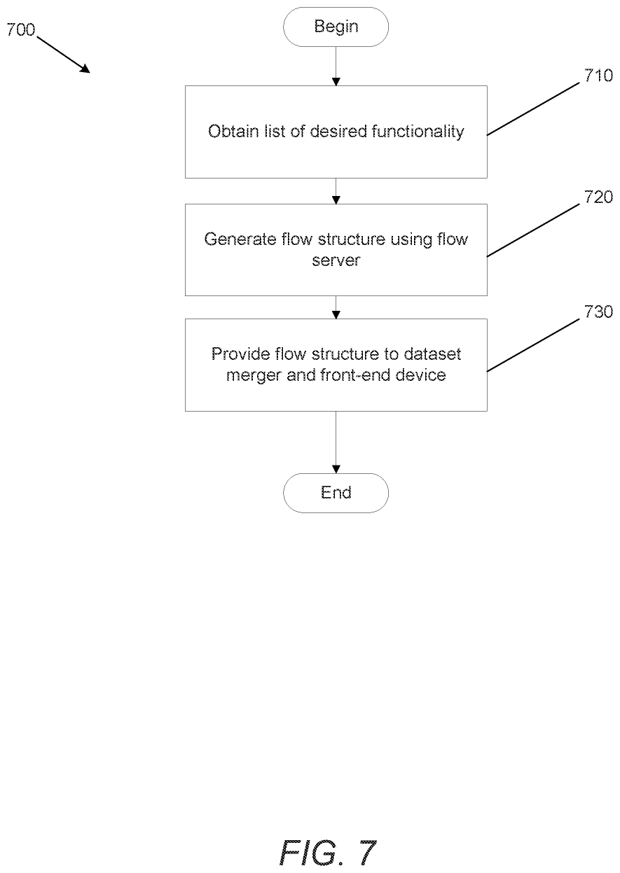

A process for generating flow structures in accordance with an embodiment of the invention is illustrated in the flow chart at FIG. 7. The process 700 includes receiving (710) a list of processing modules at a flow server that a user would like to have available for a given project. The flow server can then generate (720) a flow structure that contains all of the information needed for an interface application to generate a UI, and all of the information needed for a dataset merging application to call the right modules at the right time. The flow structure can then be provided (730) to the dataset merger and the front-end device In many embodiments, steps and links of the flow structure are ordered such that no step can be the active state unless all data necessary for the execution of its associated processing modules has been requested and obtained. In various embodiments, this includes generating a DAG representing each step and link. The flow structure as a whole can contain parameters such as a flow structure ID, a title string, a description string, image data, and/or any other UI element or metadata as appropriate to the requirements of specific applications of embodiments of the invention. Each step can have a variety of parameters including, but not limited to, a unique step ID, a label, a description, and link parameters which contain the ID of the next steps that can be reached and the steps which can precede the instant step. As noted above, each step can call one or more processing modules. Each processing module called by a step can be visualized as a substep. Substeps can encode different functionality of a given step such as, but not limited to: obtaining an input from a user; providing an output to a user; and performing analytics and/or dataset merging processes. An example flow structure for merging data sets (arbitrarily about aircraft maintenance for explanatory purposes) in accordance with an embodiment of the invention is presented below. Each step can be identified by the format <“string”:{ . . . }>, and each link can be identified by the format <“next”:[ . . . ], “previous”:[ . . . ]>, where <&> are not part of the structure. However, as can be readily appreciated, the specific formatting can be modified without departing from the scope or spirit of the invention.

{
“id”: “1”,
“title”: “Aircraft Predictive Maintenance”,
“description”: “This project flow analyzes aircraft maintenance,

flight log, sensor, and weather data to predict component failures
before they happen.”,

“image”: “image_URI”,
“start”: {

“id”: “start”,
“label”: “start flow”,
“description”: “Default start step”,
“next”: [

“1f8efda2-641f-4561-9a57-187cf66a9796”

],
“previous”: [

null
]
},
“1f8efda2-641f-4561-9a57-187cf66a9796”: {

“id”: “1f8efda2-641f-4561-9a57-187cf66a9796”,
“label”: “Data Upload”,
“description”: “Upload the corpus of news to be analyzed.”,
“next”: [

“f4b8623e-16bf-4aaa-a447-e80bea8f5fc1”

],
“previous”: [

“start”

]

},
“f4b8623e-16bf-4aaa-a447-e80bea8f5fc1”: {

“id”: “f4b8623e-16bf-4aaa-a447-e80bea8f5fc1”,
“label”: “Data Validation”,
“description”: “Validating inputs are in the expected formats.”,
“next”: [

“3b953fdd-83dc-41b2-bf45-b523b0af2850”

],
“previous”: [

“1f8efda2-641f-4561-9a57-187cf66a9796”

]

},
“3b953fdd-83dc-41b2-bf45-b523b0af2850”: {

“id”: “3b953fdd-83dc-41b2-bf45-b523b0af2850”,
“label”: “Preprocessing”,
“description”: “Data will be cleansed and some light feature
engineering.”,
“next”: [

“30831936-a0b2-40e1-bef2-55ce8504d0d0”

],
“previous”: [

“f4b8623e-16bf-4aaa-a447-e80bea8f5fc1”

]

},
“30831936-a0b2-40e1-bef2-55ce8504d0d0”: {

“id”: “30831936-a0b2-40e1-bef2-55ce8504d0d0”,
“label”: “Diagnostics”,
“description”: “Diagnostic report on the processed data.”,
“next”: [

“c14cc503-c523-4d4f-8595-e54104209dbd”

],
“previous”: [

“3b953fdd-83dc-41b2-bf45-b523b0af2850”

]

},
“c14cc503-c523-4d4f-8595-e54104209dbd”: {

“id”: “c14cc503-c523-4d4f-8595-e54104209dbd”,
“label”: “NLP and AI”,
“description”: “The news content is passed through a text
vectorizer and segmented by clustering model. ”,
“next”: [

“76a0a985-fa03-4213-9e75-445a4e262ce2”

],
“previous”: [

“30831936-a0b2-40e1-bef2-55ce8504d0d0”

]

},
“76a0a985-fa03-4213-9e75-445a4e262ce2”: {

“id”: “76a0a985-fa03-4213-9e75-445a4e262ce2”,
“label”: “Analytics and Visualization”,
“description”: “Report contains an Embedding plot and
summaries of the news segments from a transformer model.”,
“next”: [

“82ee52ea-6ab9-4dba-be6b-e5a3f570bbd9”

],
“previous”: [

“c14cc503-c523-4d4f-8595-e54104209dbd”

]

},
“82ee52ea-6ab9-4dba-be6b-e5a3f570bbd9”: {

“id”: “82ee52ea-6ab9-4dba-be6b-e5a3f570bbd9”,
“label”: “Flow archive”,
“description”: “Archiving the flow run”,
“next”: [

null

],
“previous”: [

“76a0a985-fa03-4213-9e75-445a4e262ce2”

]

}

}

In many embodiments, the IDs for each step identifies instructions for the dataset merger application to perform specific dataset merging processes. In various embodiments, the labels for each step identifies instructions for the dataset merger application to perform specific dataset merging processes. In a variety of embodiments, both the ID and the label together identifies instructions. A flow generator application can be used to automate the generation of IDs and/or labels that encode this information.

Dataset merger applications can translate flow structures into complete UIs and process the input based on the information encoded in the ID and/or labels of each step. In many embodiments, a state machine can be implemented which follows the steps and links and produces the proper outputs based on the current state as defined by the current step and links. A significant advantage of the flow structure is that one single structure can quickly be generated by a user and disseminated to all parts of the system to enable different functionalities. Further, by updating the set of processing modules, additional functionality can be added without having to modify the underlying applications in the system, and instead merely by updating the flow structure to add a new step calling the new functionality.

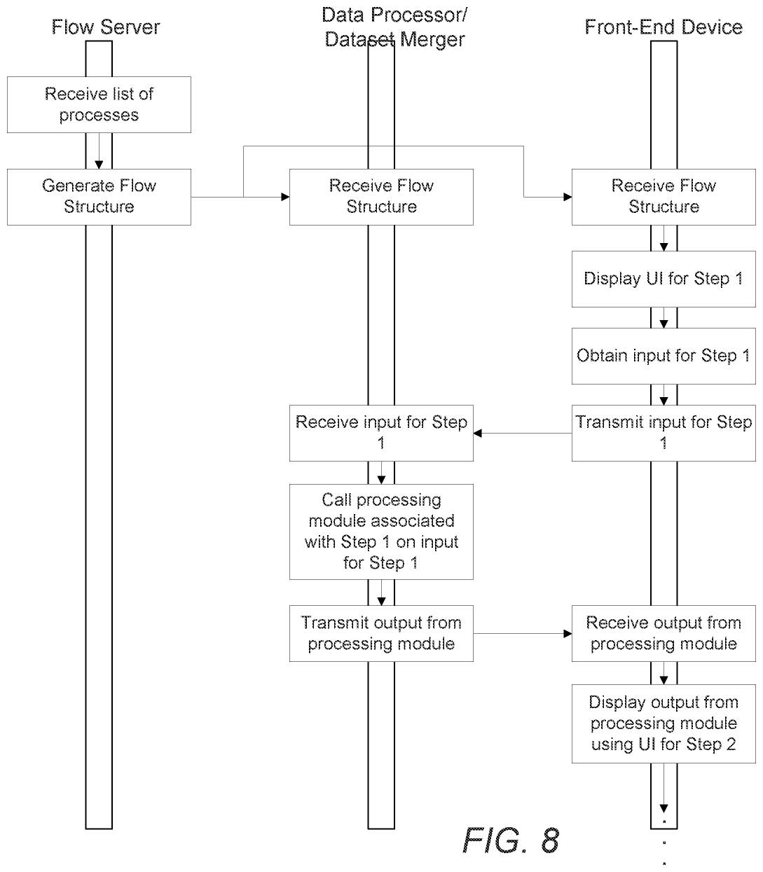

Turning now to FIG. 8, a communication diagram showing the dissemination of the flow structure and its use in accordance with an embodiment of the invention is illustrated. The flow server receives the list of processes to be included in the flow structure and generates the flow structure. The flow structure is then transmitted to the dataset merger (or in some cases as discussed above, the data processor) and front-end device(s). The front-end device(s) can then begin displaying the UI for each step in order and obtain input where necessary. The received data is transmitted to the dataset merger which then calls the processing module associated with the particular step that the front-end device requests. In many embodiments, this involves transmitting the step ID and/or the current link along with the data. In various embodiments, just the step ID and/or current link is transmitted if no new data is needed by the dataset merger. The dataset merger transmits the output back to the front-end device which then displays the results (or, depending on the active step, something else). As can be readily appreciated, the actual communication for a given flow structure may differ based on the steps defined within it. Dataset merging processes that can be performed by steps using processing modules are discussed in further detail below.

### Dataset Merging Processes

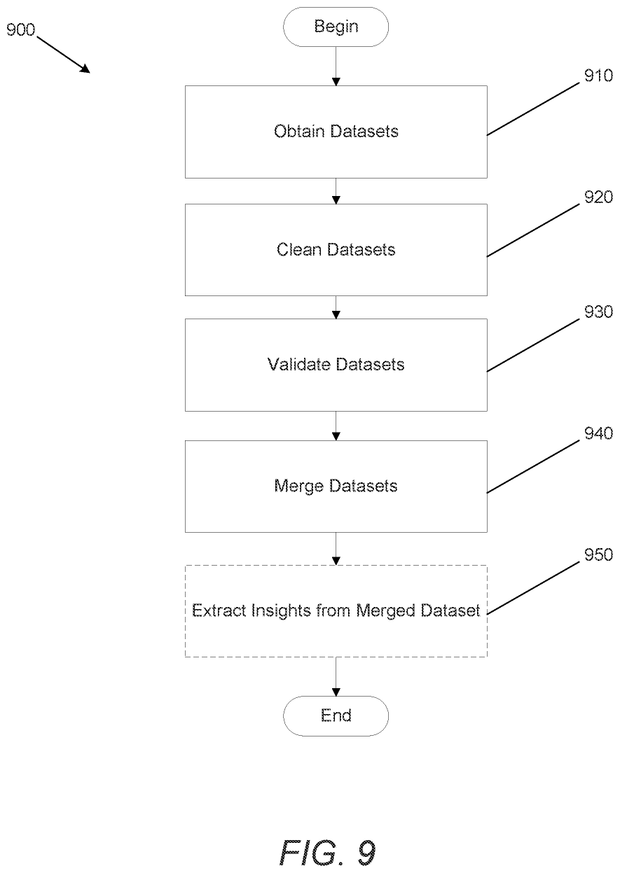

Dataset merging processes can enable the merging of disparate datasets and information into a single dataset that is validated. In many embodiments, dataset merging processes include obtaining data at a front-end device at a given step, and analyzing it at subsequent steps. In numerous embodiments, the front-end device will transmit data to a dataset merger for processing using processing modules. The dataset merger can send the data back to the front-end device for display and further user input. While any number and ordering of data processing steps can be implemented using flow structures, a common process for merging datasets in accordance with an embodiment of the invention is illustrated in FIG. 9. Process 900 includes obtaining (910) the input datasets. In many embodiments, the datasets are obtained from different sources. In various embodiments, the datasets are stored in databases which have different schema and/or contain different data. The datasets are cleaned (920) and validated (930). In numerous embodiments, the datasets are cleaned using a battery of automated data diagnostics which are discussed in further detail below. Validation processes indicate whether or not the validated datasets match their respective expected, defined formats. In many embodiments, validation steps include checksums, indicators regarding cleaned dataset schema and/or labels, a report on entries modified due to cleaning, and/or any other validation metric as appropriate to the requirements of specific applications of embodiments of the invention.

The cleaned datasets are then merged (940). In numerous embodiments, new data dimensions (e.g. columns in a table) are generated during the merging process. The merging process can include generation of a new schema based on the schema of any input databases which relates all relevant data. In numerous embodiments, the new schema is based on domain specific information extracted from the datasets. In some embodiments, organizational input from the database owner is used to guide the new schema generation.

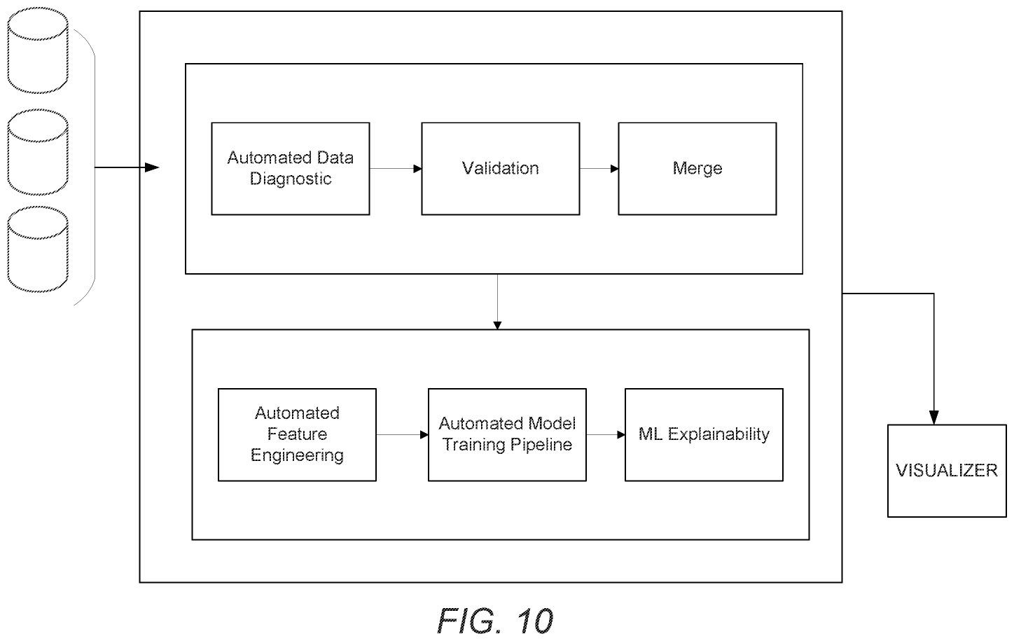

In many embodiments, insights (950) can be extracted from the merged dataset. Insight generation can be achieved using an automated machine learning process designed to generate explanations for a given target feature of the merged dataset. Both the dataset and any insights can be visualized using a visualization platform such as (but not limited to) VIP—Virtualitics Immersive Platform, by Virtualitics Inc. of Pasadena, California. A pipeline representing a merging and insight extraction process in accordance with an embodiment of the invention is illustrated in FIG. 10. However, as noted above, the ordering of steps, the number of steps, and the type of steps can all be varied based on the initial request when generating the flow structure.

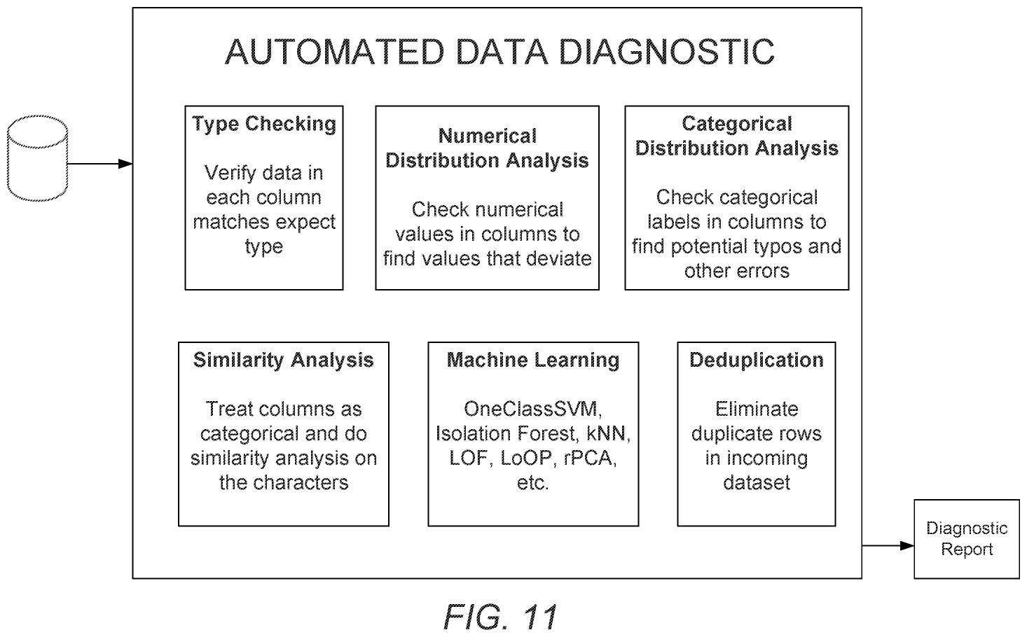

As noted above, automated data diagnostic processes can be used to clean datasets. A diagram illustrating various tasks in an automated data diagnostic battery in accordance with an embodiment of the invention is illustrated in FIG. 11. Automated data diagnostics can include (but are not limited to) type checking, numerical distribution analyses, categorical distribution analyses, similarity analyses, machine learning analysis, NLP analysis, deduplication processes, and/or any other error detection or outlier flagging process as appropriate to the requirements of specific applications of embodiments of the invention. As can readily be appreciated, not every automated data diagnostic test need be triggered depending on the schema and/or content of the input dataset. In numerous embodiments, diagnostic reports can be generated for use in validation.

While specific dataset merging and insight extraction processes have been discussed above, any number of different processes, including those that only perform insight extraction or dataset merging can be performed without departing from the scope or spirit of the invention. For easy usability, user interface (UI) elements for performing dataset merging and insight extraction processes are discussed below.

### User Interfaces

Different user interfaces can be generated for particular organizations tailor fitted to their particular datasets. In many embodiments, interface applications at front-end devices generate a specific user-interface for each step based on a received flow structure. In many embodiments, the embedded codes in the steps can indicate which UI elements are needed for a given step. In some embodiments, a database of UI elements are stored at the front-end device and can be called specifically based on each step in the flow structure. Example UI panes for different processing modules are illustrated below. However, as can be readily appreciated, UIs can be highly variable depending on the steps and even the aesthetic tastes of a particular user.

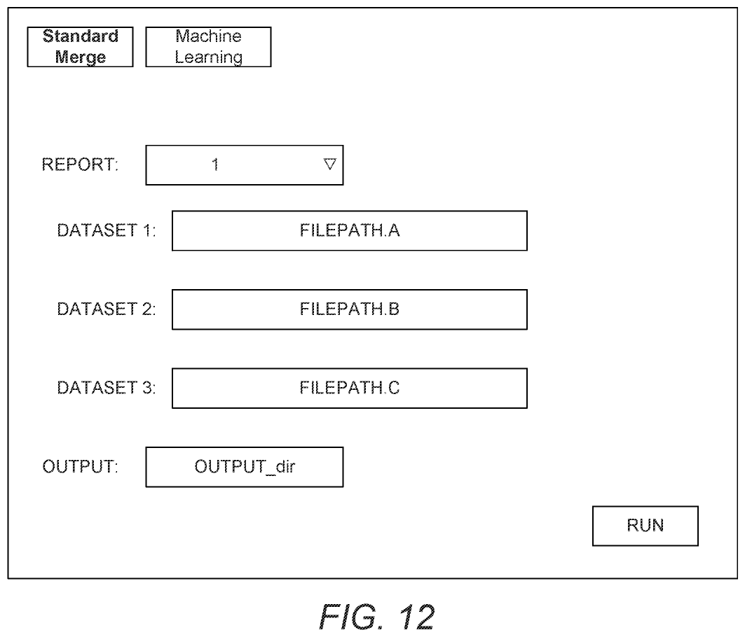

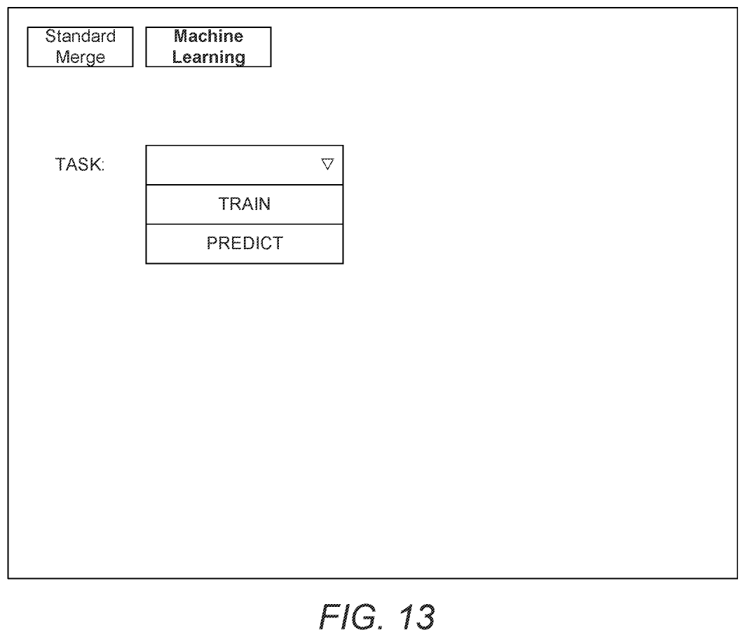

FIG. 12 illustrates a UI for merging 3 different datasets in accordance with an embodiment of the invention. As can be readily appreciated, the UI can be extended or reduced to accommodate any arbitrary number of datasets.

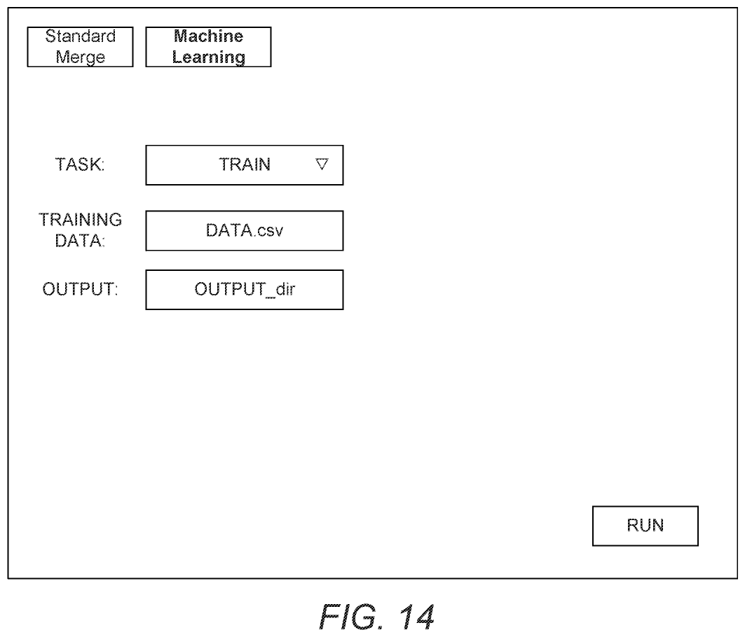

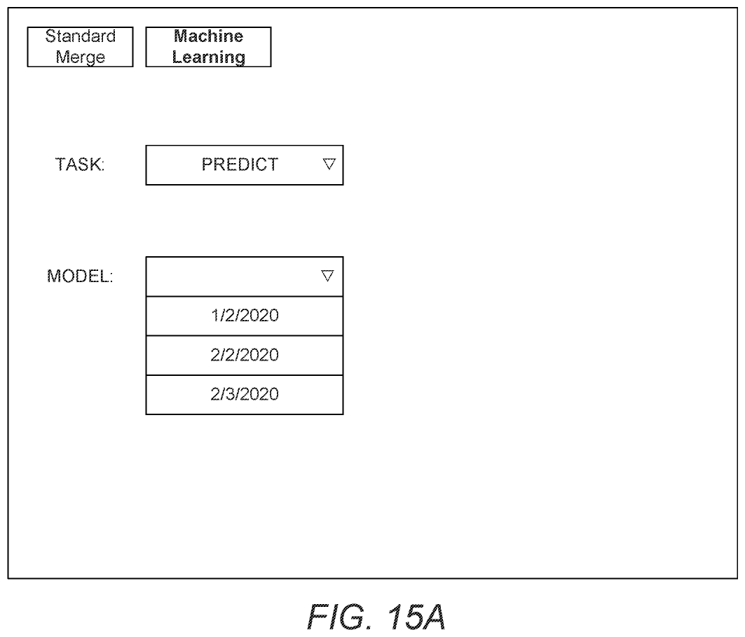

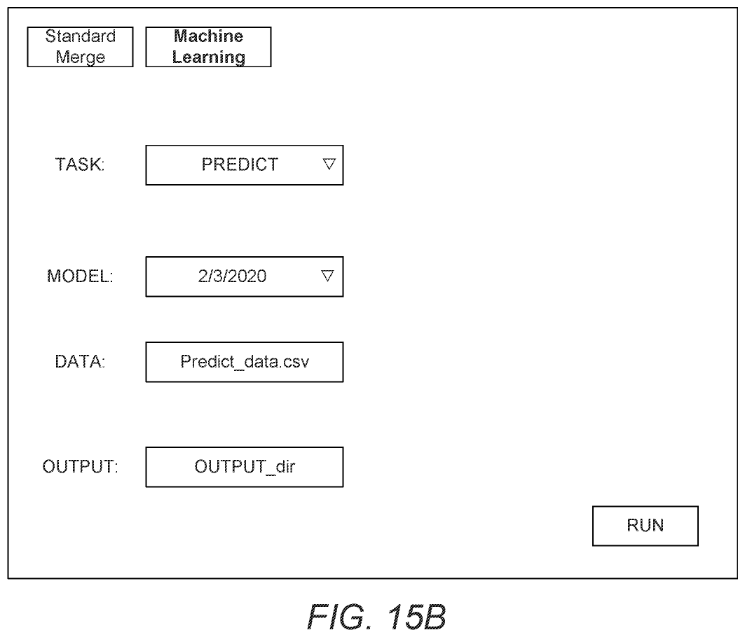

FIG. 13 illustrates a first screen of a UI for performing machine learning for insight extraction on a dataset in accordance with an embodiment of the invention. The UI provides two options for proceeding, a “TRAIN” option for training a machine learning model on the available data, and a “PREDICT” option for running the model to perform insight extraction. FIG. 14 illustrates a UI element when “TRAIN” has been elected, enabling selection of training data and a location for outputting the model in accordance with an embodiment of the invention. FIGS. 15A and 15B illustrate two consecutive UI screens for a “PREDICT” option in accordance with an embodiment of the invention. FIG. 14A illustrates selecting one of several models arbitrarily named after the date they were produced. FIG. 14B illustrates UI elements for selecting data for the selected model to be run on, as well as an output path. As one can readily appreciate, any number or UI layouts including those that use fewer or more elements, can be used as appropriate to the requirements of specific applications of embodiments of the invention. As noted above, performing dataset merging processes and/or generating end user-specific UI layouts can be time consuming and challenging using conventional methodologies that require specific, purpose-built applications. Flow structures can be used to mitigate at least these difficulties and enable more efficient and more easily deployable applications.

Although specific methods of merging datasets and extracting insights are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A data processing system comprising:
a flow server configured to:
obtain a list of desired processing modules selected from a plurality of processing modules;
generate a flow structure comprising:
a plurality of steps, where each desired processing module in the list of desired processing modules is associated with at least one step in the plurality of steps; and
a plurality of links, where each link connects a unique pair of steps in the plurality of steps; and
transmit the flow structure to a data processor storing the plurality of processing modules, and to a front-end device;
the front-end device configured to:
display a user interface (UI) for each step in the plurality of steps based on the flow structure, where one UI is displayed at a time;
obtain input data via the UI for a given step when required for processing modules associated with the given step;
transmit the obtained data to the data processor;
receive processed data from the data processor; and
display the processed data using a UI for a different step; and
the data processor configured to:
receive data from the front-end device;
process the received data using the processing modules associated with the given step; and
transmit the output of the processing modules associated with the given step as the processed data to the front-end device.

2. The data processing system of claim 1, wherein each respective step in the plurality of steps comprises:
a label; and
a unique ID.

3. The data processing system of claim 2, wherein at least one of the label and the unique ID identifies processing modules associated with the respective step.

4. The data processing system of claim 2, wherein each link comprises a unique ID of a preceding step and a unique ID of a next step.

5. The data processing system of claim 1, wherein a processing module in the plurality of processing modules cleans a dataset.

6. The data processing system of claim 1, wherein a processing module in the plurality of processing modules validates a dataset.

7. The data processing system of claim 1, wherein a processing module in the plurality of processing modules generates predictions from a dataset using a machine learning model.

8. The data processing system of claim 1, wherein the input data is a first dataset and a second dataset; and the at least one processing module associated with the given step merges the first dataset and the second dataset.

9. The data processing system of claim 1, wherein the plurality of steps form nodes in a directed acyclic graph, and the links form edges in the directed acyclic graph.

10. A method for data processing, comprising:
obtaining a list of processing modules selected from a plurality of processing modules using a flow server;
generating a flow structure using the flow server, where the flow structure comprises:
a plurality of steps, where each desired processing module in the list of desired processing modules is associated with at least one step in the plurality of steps; and
a plurality of links, where each link connects a unique pair of steps in the plurality of steps; and
transmitting the flow structure to a data processor storing the plurality of processing modules, and to a front-end device;
displaying a user interface (UI) for each step in the plurality of steps based on the flow structure, where one UI is displayed at a time using the front-end device;
obtaining input data via the UI for a given step when required for processing modules associated with the given step using the front-end device;
transmitting the obtained data to the data processor using the front-end device;
receiving data from the front-end device using the data processor;
processing the received data using the processing modules associated with the given step using the data processor; and
transmitting the output of the processing modules associated with the given step as the processed data to the front-end device using the data processor;
receiving processed data from the data processor using the front-end device; and
displaying the processed data using a UI for a different step using the front-end device.

11. The method of data processing of claim 10, wherein each respective step in the plurality of steps comprises:
a label; and
a unique ID.

12. The method of data processing of claim 11, wherein at least one of the label and the unique ID identifies processing modules associated with the respective step.

13. The method of data processing of claim 10, wherein each link comprises a unique ID of a preceding step and a unique ID of a next step.

14. The method of data processing of claim 10, wherein a processing module in the plurality of processing modules cleans a dataset.

15. The method of data processing of claim 10, wherein a processing module in the plurality of processing modules validates a dataset.

16. The method of data processing of claim 10, wherein a processing module in the plurality of processing modules generates predictions from a dataset using a machine learning model.

17. The method of data processing of claim 10, wherein the input data is a first dataset and a second dataset; and the at least one processing module associated with the given step merges the first dataset and the second dataset.

18. The method of data processing of claim 10, wherein the plurality of steps form nodes in a directed acyclic graph, and the links form edges in the directed acyclic graph.

19. A flow server for coordinating data processing across multiple computing devices, comprising:
a processor; and
a memory, containing a flow generation application, where the flow generation application directs the processor to:
obtain a list of functions for an application, where each function is capable of being performed by at least one processing module in a plurality of processing modules;
generate a plurality of steps, where each step in the plurality of steps is associated with one or more processing modules in the plurality of processing modules;
generate a plurality of links, where each link connects a unique pair of steps in the plurality of steps;
generate a flow structure comprising the plurality of steps and the plurality of links; and
transmit the flow structure to a front-end device and a data processing device, where the front-end device uses the flow structure to generate a given UI element for each given step in the plurality of steps; and where the data processing device applies a processing module associated with the given step to data acquired via the given UI element.

20. The flow server of claim 1, wherein the plurality of steps and the plurality of links can be represented as a directed acyclic graph, where steps are nodes and links are edges.
